(19) United States
(12) Patent Application Publication
(10) Pub. No.: US 2005/0220564 A1
(43) Pub. Date: Oct. 6, 2005

(54) FASTENER ASSEMBLY WITH WAVE SPRING

(76) Inventors: Kerry D. Hinson, Buchanan, TN (US); Gary W. Hunter, Paris, TN (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/708,928

(22) Filed: Apr. 1, 2004

(51) Int. Cl. F16B 21/18

(52) U.S. Cl. 411/353

(57) ABSTRACT

A fastener assembly that acoustically decouples a workpiece from direct contact with a supporting structure includes a threaded fastener having a head portion and a shaft portion, a retention sleeve disposed about the threaded fastener, and a wave spring disposed about the retention sleeve. When used to secure a valve cover to an engine cylinder head, the fastener assembly acoustically decouples the valve cover from the engine cylinder head. As a result, engine structural noise, vibration and harshness (NVH) is reduced.

### FIELD OF INVENTION

The present invention relates to a fastener assembly that acoustically decouples a workpiece from direct contact with a supporting structure. More particularly, the invention relates to a fastener assembly with a wave spring for acoustically decoupling two members of an engine, such as a valve cover and an engine cylinder head, to reduce engine structural noise, vibration and harshness (NVH).

### BACKGROUND OF THE INVENTION

Automotive power train designers have had significant problems over recent years in reducing engine structural noise, vibration and harshness (NVH) related to various moving or vibrating components of the under-the-hood engine assembly. One source of moving or vibrating components is the engine valve cover that is mounted to the cylinder head by use of a fastener assembly. Typically, the fastener assembly consists of a rubber grommet between the head of the fastener and the cover or component being fastened to inhibit transmission of NVH.

Although conventional fastener assemblies that use rubber grommets help diminish the noise emanating from the valve cover, conventional fastener assemblies still transmit significant structural noises, vibrations, or the like. In addition, the rubber grommet has a tendency to be become more brittle under high temperature, demonstrates a relatively high rate of compressive stress relaxation, and is prone to attack from chemicals and cleaners.

Accordingly, there has been a long felt need in the art for an economical and efficient fastener assembly that can be suitably used in the securing of valve covers on an automotive engine, and which will also assist in substantially reducing structural noise, vibration, and harshness normally associated with the automotive engine.

### SUMMARY OF THE INVENTION

The present invention is directed to a fastener assembly for securing a valve cover to an engine head. The fastener assembly comprises a threaded fastener having a head portion and a shaft portion, a retention sleeve disposed about the threaded fastener, and a wave spring disposed about the retention sleeve, wherein the fastener assembly acoustically decouples the valve cover from the engine head.

### BRIEF DESCRIPTION OF THE DRAWINGS

FIG. 1 is a cross sectional view of a fastener assembly according to an embodiment of the invention;

FIG. 2 is a perspective view of a wave spring according to the embodiment of the invention;

FIG. 3 is a graph illustrating pressurization test results of a conventional fastener assembly with grommet;

FIG. 4 is a graph illustrating pressurization test results of the fastener assembly with wave spring of the invention;

FIG. 5 is a graph illustrating a comparison of standoff test results between a conventional fastener assembly with grommet and the fastener assembly with wave spring of the invention; and

FIG. 6 is a graph illustrating a comparison of transmissibility test results between a conventional fastener assembly with grommet and the fastener assembly with wave spring of the invention.

### DETAILED DESCRIPTION OF THE PREFERRED EMBODIMENTS

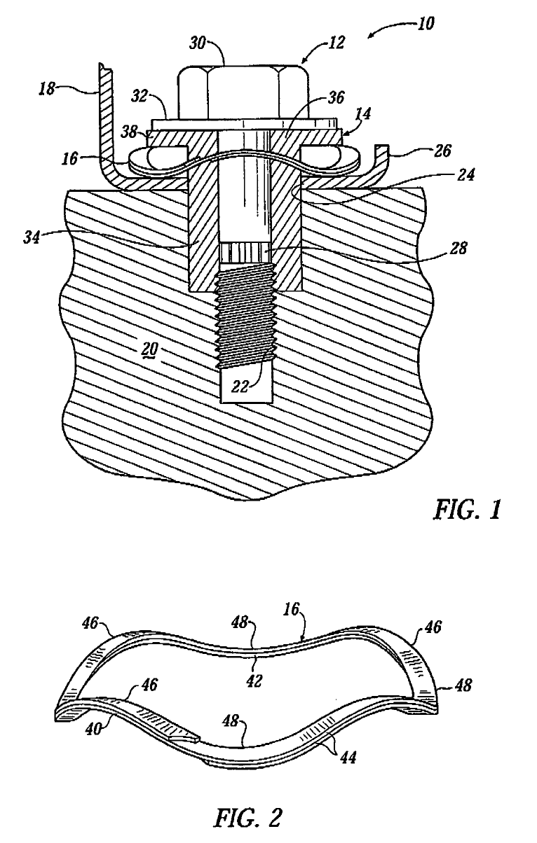

Referring now to FIG. 1, a fastener assembly 10 is shown according to an embodiment of the invention. In general, the fastener assembly 10 includes a threaded fastener, such as a shoulder bolt 12, a limiter or retention sleeve 14 disposed about the threaded fastener 12, and a wave spring 16 disposed about the retention sleeve 14. In the illustrated embodiment, the fastener assembly 10 is used to attach two members of an engine, such as a valve cover 18 to a cylinder head 20. The cylinder head 20 has a threaded bore 22 adapted to receive the shoulder bolt 12 and the valve cover 18 has an aperture 24 through a flange portion 26 for receiving the fastener assembly 10.

The threaded fastener 12 includes a threaded shank portion 28 and an enlarged head portion 30. The head portion 30 includes a radially projecting collar 32. The shank portion 28 is adapted to be threadably inserted into the threaded bore 22, which causes the head portion 30 to be moved downward toward the cylinder head 20. Preferably, the threaded fastener 12 is manufactured of a metallic material.

The retention sleeve 14 has a smooth cylindrical section 34 that has an inner diameter that is slightly larger than the outer diameter of the threaded shank portion 28 so that displacement of the threaded fastener 12 in the retention sleeve 14 is possible. At the upper end of the smooth cylindrical section 34, the retention sleeve 14 has a narrow location in the form of a circumferential necking 36 extending radially to form a slightly bulged contour on the inner side of the retention sleeve 14. The circumferential necking 26 has an inner diameter at the location of its smallest cross section that is slightly smaller than the outer diameter of the threaded shank portion 28 of the threaded fastener 12, but slightly larger than the outer diameter of a smooth-cylindrical region of the threaded shank portion 28 of the threaded fastener 12. Thus, in the region of the necking 36, there is practically no play present between the retention sleeve 14 and the threaded fastener 12.

The upper end the retention sleeve 14 has a radially outwardly projecting head flange 38 that abuts the radially projecting collar 32 of the head portion 30 and acts as a stop or limiter to prevent the wave spring 16 from being disposed past the head portion 30. The outer diameter of the head flange 38 is slightly larger than the outer diameter of the radially projecting collar 32 of the head portion 30. However, the invention can be practiced where the outer diameter of the head flange 38 is equal to or less than the outer diameter of the radially projection collar 32. Preferably, the retention sleeve 14 is manufactured of a metallic material similar to the threaded fastener 12 by a shaping procedure. However, the retention sleeve 14 may also be manufactured by swarf-producing machining, for example, by turning, or the like. The threaded fastener 12 and the retention sleeve 14 are commercially available from ITW Automotive Products GmbH & Co. of Iserlohn, Germany.

The wave spring 16 is formed of a single, flat elongate metal strip 40 that is wound about one of its lateral edge 42 in a generally circular pattern to form a multi-turn ring in which the consecutive turns 44 of the wave spring 16 are closely spaced together and lie adjacent one another. Each flat turn is generally parallel to its adjacent turn. The strip 40 is formed into a continuous wave path that consists of a series of successive similar wave crests 46 and troughs 48. The wave path is continuous and substantially sinusoidal in nature. The wave spring 16 has an inner diameter slightly larger than the outer diameter of the retention sleeve 14 such that the wave spring 16 abuts the head flange 38 of the retention sleeve 14. In operation, the wave spring 16 prevents substantial lateral movement of either the valve cover 18 to the cylinder head 20 when fastened together by the threaded fastener 12 and acoustically decouples the valve cover 18 from the cylinder head 20. The wave spring 16 is commercially available from Smalley Steel Ring Company of Wheeling, Ill.

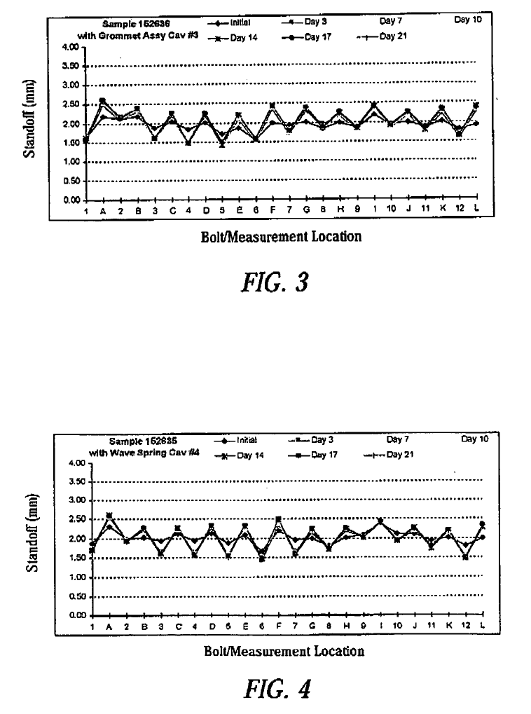

Tests were performed to evaluate the performance of the fastener assembly 10 of the invention and compare the performance to that of a conventional fastener assembly using a rubber grommet instead of the wave spring of the invention. In a pressurization test, one valve cover was assembled using a traditional rubber grommet and another valve cover was assembled using the wave spring 16 of the invention. The valve cover assemblies were tightened using 14 N/m of torque. Initial standoffs were taken and recorded. A 95% water/5% soap solution was sprayed around the perimeter of the assemblies. Initial air pressurization to 5 psi was performed with the results recorded. After initial air testing, the valve covers were then placed into a 250° F. over for three days. On the third day, the valve covers were removed from the over where standoffs and oil pressurization test to 5 psi was performed with results recorded. Oil was changed and the valve covers were returned to the oven at a temperature of 250° F. Pressurization, standoffs and oil change also occurred on days 7, 10, 14 and 17 with the results recorded. On day 21, after final standoffs and pressurization testing to 5 psi were taken and recorded, the valve covers were disassembled and a visual inspection was performed. The results of the testing are shown in FIGS. 3 and 4.

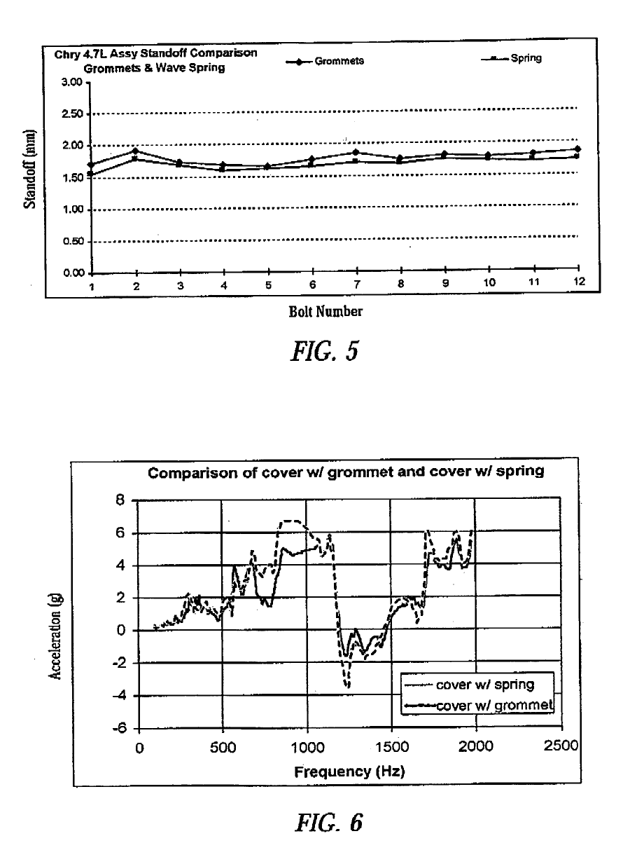

In a vibration sweep test, one valve cover was assembled using a traditional rubber grommet and another valve cover was assembled using the wave spring 16 of the invention. The valve cover assemblies were tightened using 14 N/m of torque. Initial standoffs were taken and recorded. Each valve cover was mounted to a vibration/shaker table and accelerometers were placed on the cover in five locations. A sweep of 100-2000 Hz at 1 g and temperature of 68° F. was performed. At the conclusion of the test, each valve cover was disassembled and visually inspected. The results of the vibration sweep testing are shown in FIGS. 5 and 6.

In summary, the unexpected results of the pressurization and vibration sweep testing indicated that the fastener assembly 10 of the invention with the wave spring 16 performed as well, if not better, than the conventional fastener assembly using a rubber grommet. Specifically, the pressurization testing indicates that the fastener assembly 10 of the invention maintains the sealing action between the valve cover and the cylinder head as well, if not better, than the conventional fastener assembly using a rubber grommet. In addition, the vibration sweep testing indicates that the fastener assembly 10 of the invention acoustically decouples the valve cover 18 from the cylinder head 20 as well, if not better, than the conventional fastener assembly using a rubber grommet. One desirable aspect of the invention is that the fastener assembly 10 can be manufactured at less cost as compared to conventional fastener assemblies using rubber grommets. Another desirable aspect of the invention is that the fastener assembly 10 has improved long term durability as compared to conventional fastener assemblies using rubber grommets.

It is to be understood that the above description is intended to be illustrative and not limiting. Many embodiments will be apparent to those of skill in the art upon reading the above description. Therefore, the scope of the invention should be determined, not with reference to the above description, but instead with reference to the appended claims, along with the full scope of equivalents to which such claims are entitled.

1. A fastener assembly for coupling at least two components of an engine, comprising:
a threaded fastener having a head portion and a shaft portion;
a retention sleeve disposed about the threaded fastener; and
a wave spring disposed about the retention sleeve; wherein the wave spring has an inner diameter slightly larger than an outer diameter of the retention sleeve and wherein the fastener assembly acoustically decouples the components.

2. (canceled)

3. The fastener assembly according to claim 1, wherein the head portion of the threaded fastener includes a radially projecting collar.

4. The fastener assembly according to claim 1, wherein the retention sleeve includes a radially outwardly projecting head flange.

5. The fastener assembly according to claim 1, wherein the threaded fastener, the retention sleeve, and the wave spring are made of metallic material.

6. The fastener assembly according to claim 1, wherein the wave spring abuts a portion of the retention sleeve such that the wave spring is selectively prevented from being fully compressed.

7. A fastener assembly for coupling at least two components of an engine, comprising:
a threaded fastener;
a retention sleeve disposed about the threaded fastener, wherein the retention sleeve includes a flange section and a necking portion that extends downward from the flange section; and
a wave spring disposed about the retention sleeve; wherein the fastener assembly acoustically decouples the components.

8. The fastener assembly according to claim 7, wherein the flange section has a circumferential extent that is greater than the necking portion,
